(19) United States
(12) Patent Application Publication
(10) Pub. No.: US 2025/0270461 A1
(43) Pub. Date: Aug. 28, 2025

(54) A process for producing syngas using exogenous CO2 in the absence of carbon fuels

(71) Applicant: Politecnico di Milano, Milano MI (IT)

(72) Inventors: Flavio MANENTI, Milano MI (IT); Filippo BISOTTI, Milano MI (IT)

(21) Appl. No.: 18/858,033

(22) PCT Filed: Apr. 21, 2023
(86) PCT No.: PCT/EP2023/060520

§ 371 Date: Oct. 18, 2024

(30) Foreign Application Priority Data
Apr. 22, 2022 (IT) 102022000008117

(51) Int. Cl. C10K 3/02; C25B 1/042; C25B 15/08

(52) U.S. Cl. CPC C10K 3/026; C25B 1/042; C25B 15/081

(57) ABSTRACT

A process for producing syngas with a H₂/CO ratio of from 0.5 to 3.5, comprising:
a) generating steam by burning hydrogen and oxygen in the presence of steam in a H₂ burner,
b) quenching the effluents from step a);
c) conducting an electrolysis on steam from step b) in a solid oxide electrolytic cell (SOEC) thereby obtaining hydrogen and oxygen,
d) cooling wet hydrogen gas coming from step c) and removing water by condensation;
e) carrying out a reverse water gas shift reaction with hydrogen gas coming from step d) with CO2, coming from an external source, thereby obtaining syn gas;
f) cooling wet syngas coming from step e) and removing water by condensation thereby obtaining dry syngas.

### FIELD OF THE INVENTION

The present invention relates to a process for producing syngas by using only as carbon source CO₂ coming from an external source.

Conventional processes for preparing syngas are typical processes occurring in the presence of high amounts of methane both used as reactant in the typical reforming reactions:

CH₄+CO₂→2CO+2H₂

CH₄+H₂O→CO+3H₂

and as fuel necessary for carrying out the combustion reaction

CH₄+2O₂→CO₂+2H₂O

for providing the required energy to carry out the above endothermic reforming reactions and for providing part of steam and CO2 to be used as reactants in the aforementioned reactions.

However nowadays the need is felt to produce syngas possibly reducing carbon fuels responsible for producing high amounts of greenhouse CO₂.

### SUMMARY OF THE PRESENT INVENTION

Now the Applicant has found that the drawbacks of conventional processes for producing syngas can be overcome with the process of the invention, using as the sole carbon source waste CO₂ separated from flue gases or coming from other production processes like calcination in the preparation of cement or steel mills.

The process according to the present invention comprises the following steps:
a) generating steam by burning hydrogen and oxygen in the presence of steam in a H₂ burner at a temperature higher than 1000° C., at a pressure comprised between 10 and 40 bar, according to the following reaction scheme:

H₂+0.5O₂→H₂O [R1]
b) quenching and optionally further cooling the effluents from step a) at a temperature comprised between 800 and 900° C.;
c) conducting at a temperature between 800 and 900° C. at a pressure comprised between 10 and 40 bar an electrolysis in a solid oxide electrolytic cell (SOEC) on steam coming from step b) thereby obtaining hydrogen and oxygen;
d) cooling wet hydrogen gas coming from step c) and removing water by condensation.
e) carrying out a reverse water gas shift reaction with hydrogen gas coming from step d) with CO₂, coming from an external source, according to the following reaction scheme:

CO₂+H₂=CO+H₂O [R2]

thereby obtaining syngas provided that said hydrogen gas is fed in said step in amounts of from 0.5 to 3 moles, with respect to CO2;
f) cooling wet syngas coming from step e) and removing water thereby obtaining dry syngas with the required H₂/CO ratio.

A further subject of the present invention is the apparatus for carrying out the process according to the present invention comprising:
A) an H₂ burner unit for carrying out step a) in fluid direct communication with a steam quencher for carrying out step b),
B) the steam quencher for carrying out step b) this unit being in fluid communication with the H₂ burner and a solid oxide electrolytic cell (SOEC) unit,
C) the solid oxide electrolytic cell wherein the step c) takes place, in fluid communication with the H₂ burner unit and a reverse water gas shift reaction unit;
D) the water gas shift reaction unit being in fluid communication with the H2 burner and with the solid oxide electrolytic cell.

### DESCRIPTION OF THE FIGURES

FIG. 1 is a block diagram of the process of the invention.

FIG. 2 is a schematic representation of a particularly preferred embodiment of the apparatus according to the present invention.

FIG. 3 is a graphic wherein in left ordinates Power is reported measured as kWh/kg of H₂ produced, in abscissae the outlet temperature of SOEC and in the right ordinates the inlet temperatures of SOEC, x is the molar fraction of steam converted after electrolysis.

FIG. 4 is a schematic representation of a further preferred form of the apparatus according to the present invention.

FIG. 5 reports the steam spreadsheet obtained by carrying out the Aspen Hysys v11 simulation on the apparatus reported in the previous Figure.

FIG. 6 reports another preferred embodiment of the apparatus according to the present invention.

FIG. 7 reports another preferred embodiment of the apparatus according to the present invention.

FIG. 8 reports another preferred embodiment of the apparatus according to the present invention.

### DETAILED DESCRIPTION OF THE INVENTION

For the purposes of the present invention the term “comprising” does not exclude the possibility that further components/steps not expressly mentioned in the list after said wording are contemplated.

The wording “consist of” excludes such a possibility.

The term “apparatus” comprises one or more units, said units being selected from separators or splitters heat exchange system waste heat boiler, water condenser and reactors like H₂ burners, SOEC, reverse water gas shift reactor or units comprising inside one or more of the said reacting units, heat exchange systems, etcetera.

For the purposes of the present invention as exogenous CO₂, CO₂ coming from an external source we mean waste CO₂ from flue gas or calcination, previously separated in absorption columns, pressure swing absorption unit et cetera.

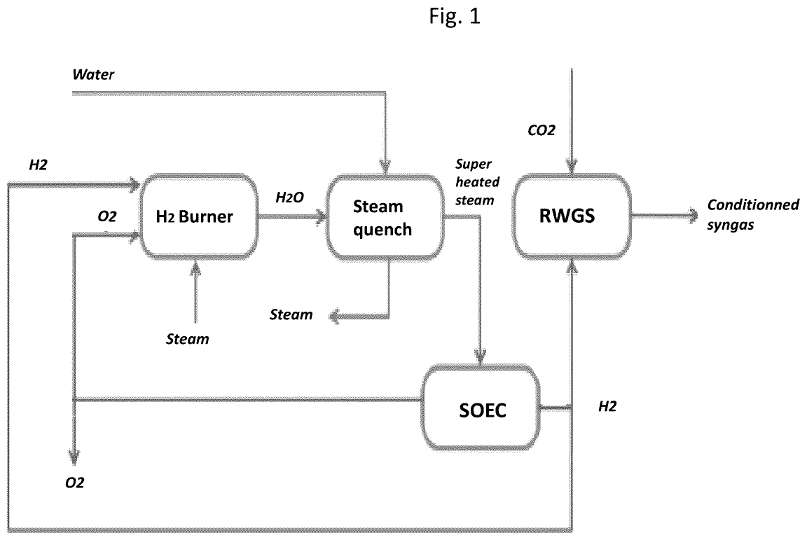

A block diagram of the process and of the plant of the invention is reported in FIG. 1.

Step a) of the process of the invention is preferably carried out in the H₂ burner at temperatures higher than 1100° C., even more preferably at temperatures ranging from 1100 to 1300° C. Preferably it is carried out at a pressure of 30 bar.

Steam is added in step a) in molar amounts preferably ranging from 1 to 4 with respect to the sum of molar amount of fed hydrogen and oxygen.

In step b) the hot effluents are cooled to temperature of 850° C., at pressure of 30 bar.

Step b) may be carried out in a quench unit by using as a cooling fluid a cooler steam stream.

In this case the quenched steam stream may preferably be further cooled in a boiler, wherein a pressurized cool water stream preferably at a pressure of 30 bar is used as a cooling fluid.

In alternative when in step b) only quenching is carried out, it takes place in a quencher wherein the hot effluents coming from step a) are directly contacted with a stream of cool water pressurized at a pressure of from 10 to 40 bar, preferably at 30 bar.

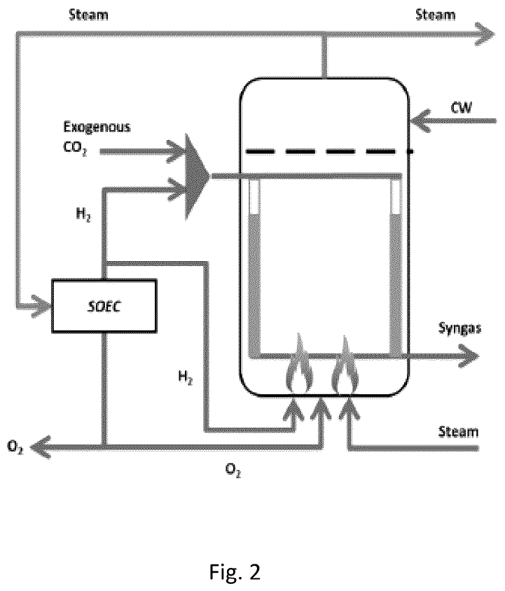

The electrolysis step carried out in a SOEC unit is preferably conducted at 850° C. which is the optimal temperature as deduced by the graphic of FIG. 2 reported in M. Hillestad et al “Improving carbon efficiency and profitability of the biomass to liquid process with hydrogen from renewable power” Fuel 234 (2018) 1431-1451.

The oxygen produced in step c) is pure oxygen and preferably is partly recycled at step a), whereas the remaining part is stocked for being sold as high-grade oxygen.

The hydrogen is preferably totally consumed: a part is adopted as feedstock for the H₂ burner to generate the required steam, whereas the remaining part is fed in step e) to the Reverse Water-Gas Shift reactor where exogenous CO₂ is also fed.

Hydrogen, leaving the SOEC is wet, therefore, before being subjected to the reverse water gas shift reaction, in step d) it is cooled and the water is removed by condensation.

The process allows to obtain a syngas having a ratio H₂/CO comprised between 0.5 and 3.5.

In this case H₂ must be fed to the reverse water gas shift in amounts of from 0.5 to 3.5 moles with respect to CO2.

For obtaining an H₂/CO ratio preferably ranging from 1 to 3.5, hydrogen gas must be added in amounts of from 1 to 3.5 moles with respect to CO2 molar amounts in the reaction [R2] and for obtaining syngas having a ratio of H₂/CO of from 2 to 3.5 in the same step H₂ is preferably added in amounts of from 2 to 3.5 moles with respect to CO2 [R2].

The process according to the present invention preferably encompasses that in step b) the steam stream leaving the boiler or the steam stream leaving the quencher is split into two streams, wherein the first one is sent to SOEC and the second one is sent to a turbine and expanded or in alternative after being previously cooled, is recycled to step (a).

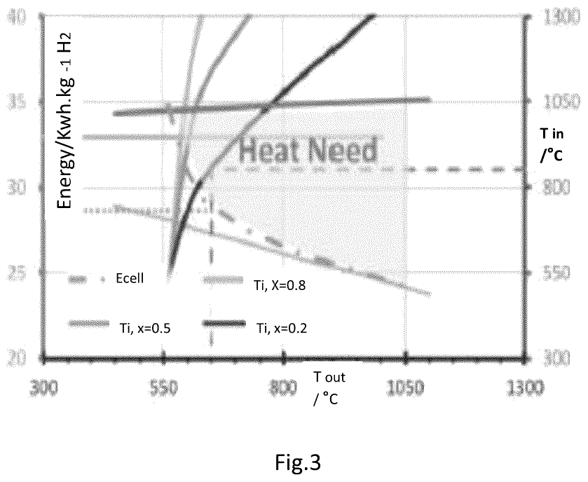

According to a particularly preferred embodiment of the apparatus according to the present invention is that represented in FIG. 3, wherein the unit A), B) and D) are comprised in a sole unit comprising:
i) a shell being a H2 burner, coinciding with unit A)
ii) said shell surrounding a tube bundle coinciding with unit C)
iii) said shell comprising a steam quenching unit, coinciding with unit B)
   said unit being further provided:
with three inlets for H2, O2 and steam at the shell side,
with an outlet for hot effluents at the shell side;
an inlet for cold water (CW) at the shell side in fluid communication with the quenching unit;
with an inlet for introducing the reactants at the tube side and
an outlet for syngas formed at the tube side.

Preferably the quencher or quenching unit iii) is of direct type selected from a spray nozzle crown, or of indirect type selected from a heat exchanger or a waste heat boiler.

Preferably the outlet of the shell side effluents is at the top of said unit, the inlet of the tube side reactants is at the top of said unit and the outlet the tube side effluents are at the bottom of the unit and the steam quenching unit is placed at the top of said unit, like that reported in FIG. 3.

In this case the process according to the present invention is carried out according to the following procedures oxygen, hydrogen and steam enter at the bottom of the shell side and at the top of the tubes side of the unit whereas CO2 and H2 enter, the tubes are heated by the exothermic reaction occurring at the shell side, so that the endothermic reverse water gas shift reaction takes place and the syngas produced leaves the unit at the bottom, whereas steam used both for mitigating the combustion occurring at the shell side and that formed in said combustion hot effluents enters enter a cooling zone where their temperature is regulated by contact with cold water by passing through spray nozzle crown before leaving unit and being partially provided to SOEC.

According to another embodiment of this apparatus the outlet of the shell side effluents is at the bottom of the unit, the inlet of the tube side reactants is at the bottom of the unit and the outlet of the tube side effluents is at the top of the unit, the shell side steam quenching unit is at the bottom of this unit.

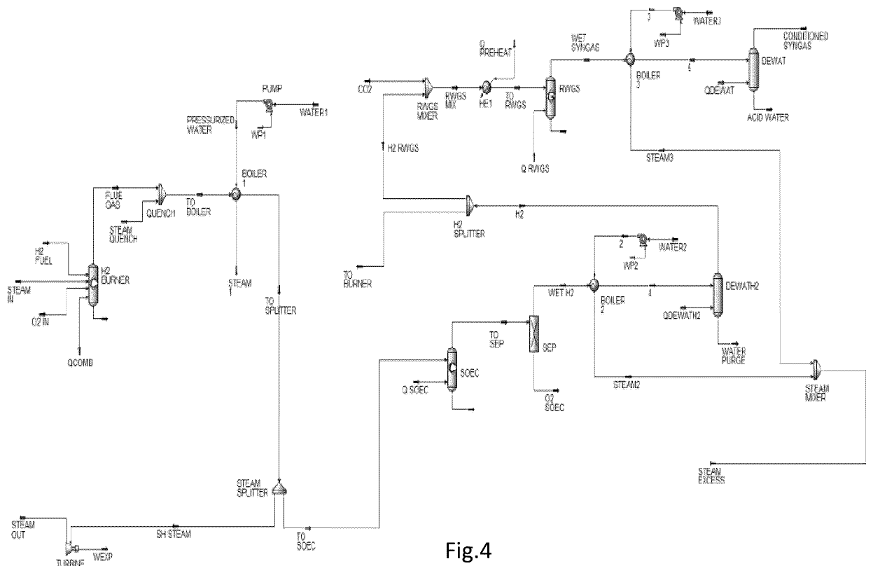

Another embodiment of the apparatus is reported in FIG. 4 In this configuration H₂ (H2 FUEL), O₂ (O₂ IN), and steam (STEAM IN) are burnt to generate heat and additional steam (FLUE GAS). This flue gas contains only steam and a very small quantity of residual (over stoichiometric) oxygen. Due to the high temperature of the flue gas stream, a quenching is required using steam (STEAM QUENCH). The steam leaving the QUENCH unit, is then furtherly cooled in BOILER 1 up to 850° C. which is the steam temperature for SOEC feed. The released heat is exploited to generate steam (STEAM1). The cooled steam (TO SPLITTER) is then sent to STEAM SPLITTER. A fraction of the superheated steam is expanded in the TURBINE unit, the remaining part (TO SOEC) is sent to the SOEC unit. The resulting produced oxygen (O₂ SOEC) is in large excess with respect to the required oxygen in H₂ BURNER. The wet hydrogen stream (WET H₂) is sent to a cooling system (BOILER 2) and then to a dewatering flash condenser (DEWAT H₂).

The dry hydrogen (H₂) is split into a first stream (TO BURNER) which is recycled back to the burner to sustain the flame, while the other stream (H₂ RWGS) is mixed with external CO₂ stream. The resulting stream (RWGS MIX) is preheated in HE1, and the warm stream is fed to RWGS unit where the endothermic reverse water-gas shift reaction occurs. The resulting WET SYNGAS is cooled in BOILER3, and the water removed in DEWAT unit. The CONDITIONED SYNGAS has the optimal SN for the methanol synthesis and H₂/CO>3. Thanks to the heat recovery it is possible to collect the excess steam (STEAM EXCESS) that in combination with STEAM1 satisfy the steam demand (STEAM IN) in H₂ BURNER.

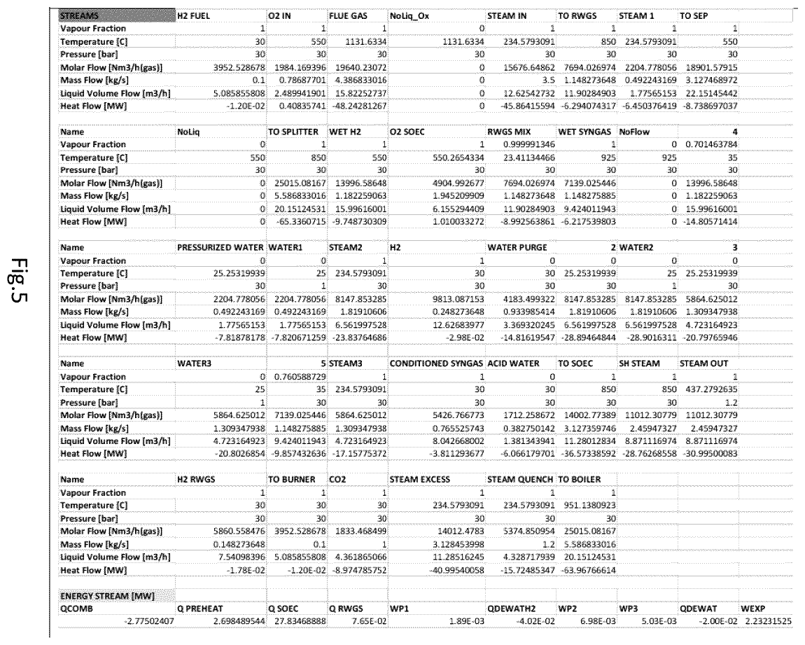

In FIG. 5 the corresponding Steam stream spreadsheet is reported of the simulation carried out with the apparatus reported in FIG. 4 by using Aspen HYSYS v.11 simulator.

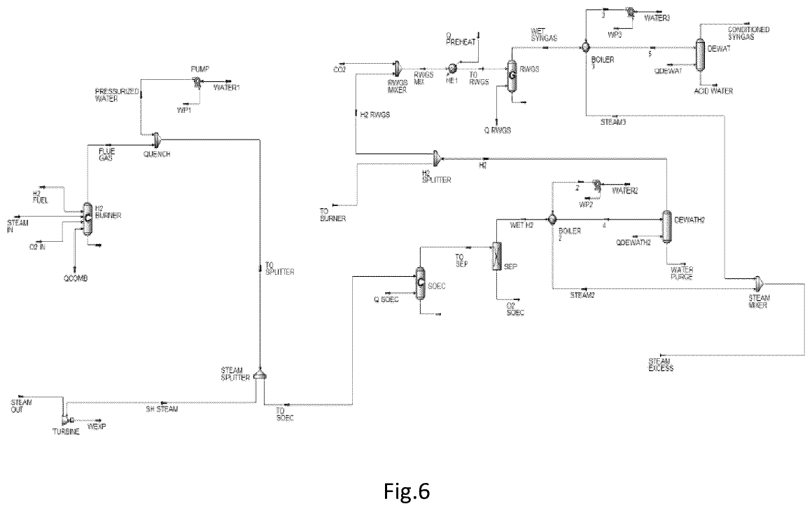

In FIG. 6 a further preferred embodiment of the apparatus disclosed in FIG. 4 differing from that of FIG. 4 in that FLUE GAS is not any longer quenched by indirect methods, but through direct contact by means of pressurized water.

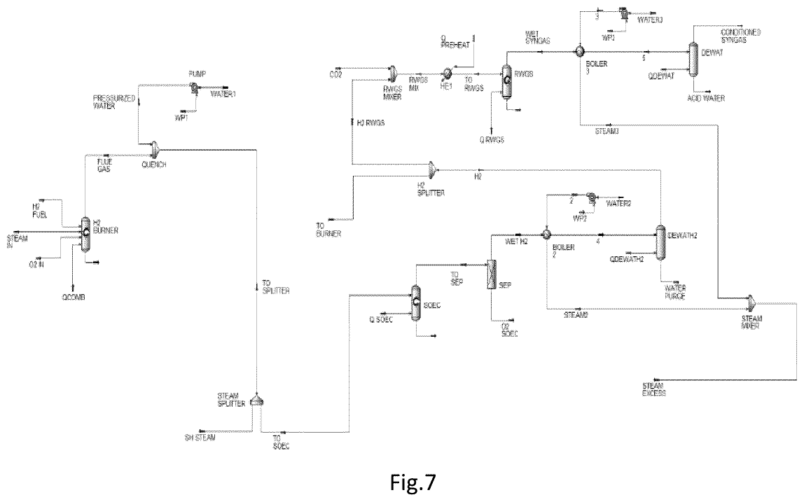

In FIG. 7 an apparatus is disclosed like that disclosed in FIG. 4 with the following two differences:
FLUE GAS steam is quenched through direct contact with cold pressurized water.
In addition, the turbine is removed, hence SH STEAM is a free steam stream which can be furtherly cooled and then recycled to H₂ BURNER.

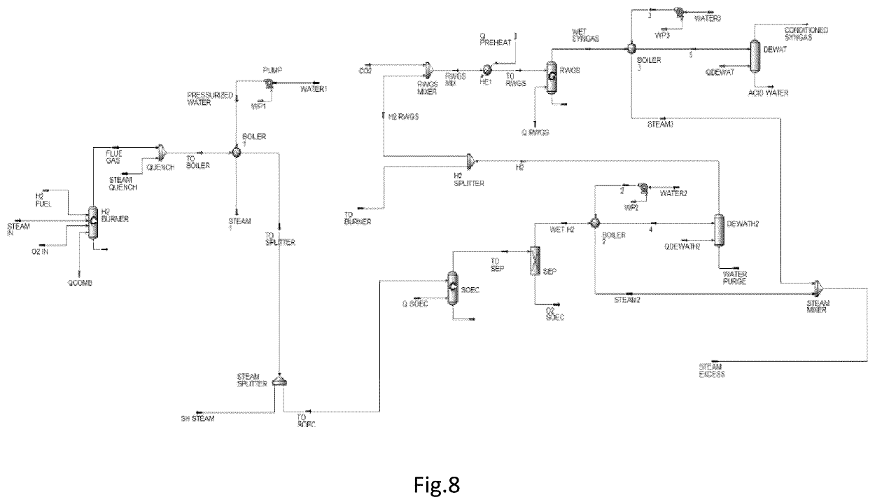

In FIG. 8 another preferred embodiment of the apparatus of FIG. 4 is disclosed differing from that reported in FIG. 4 in that there is no turbine, hence, the superheated steam (SH STEAM), is a free steam which can be furtherly cooled and then recycled to H₂ BURNER.

1. A process for producing syngas with a H₂/CO molar ratio of from 0.5 to 3.5, comprising:
a) generating steam by burning hydrogen and oxygen in the presence of steam in a H₂ burner at a temperature higher than 1000° C. at a pressure comprised between 20 and 40 bar according to the following reaction scheme
H₂+0.5O₂→H₂O [R1]
b) quenching and optionally further cooling the effluents from step a) at a temperature comprised between 800 and 900° C. at a pressure of from 10 to 40 bar;
c) conducting an electrolysis in a solid oxide electrolytic cell (SOEC) on steam coming from step b) at a temperature comprised between 800 and 900° C. and at a pressure between 10 and 40 bar thereby obtaining hydrogen and oxygen,
d) cooling wet hydrogen gas coming from step c) and removing water by condensation.
e) carrying out a reverse water gas shift reaction with hydrogen gas coming from step d) with CO2, coming from an external source, according to the following reaction scheme:
CO₂+H₂=CO+H₂O [R2]
thereby obtaining syngas provided that said hydrogen gas is fed to said reactor in molar amounts with respect to CO2 of from 0.5 to 3.5 moles, thereby obtaining wet syngas;
f) Cooling wet syngas coming from step e) and removing water thereby obtaining dry syngas with the required H₂/CO molar ratio.

2. The process according to claim 1, for producing syngas having H₂/CO molar ratio of from 1 to 3.5 in step e) hydrogen gas is fed in amounts of from 1 to 3.5 moles with respect to CO2 molar amount.

3. The process according to claim 1 for producing syngas with a H₂/CO moloar ratio comprised between 2 and 3.5 wherein in step e) hydrogen gas is fed in amounts of from 2 to 3.5 moles with respect to CO2 molar amount.

4. Process according to claim 1 wherein in step a) steam is fed in molar amounts ranging from 1 to 4 with respect to the sum of molar amount of fed hydrogen and oxygen

5. The process according to claim 1, wherein in step b) quenching is conducted in a quench unit by passing separately, as a cooling fluid, a stream of steam and the quenched effluents are further cooled in a boiler wherein cool water and pressurized at a pressure of from 10 to 40 bar is used as a cooling fluid.

6. The process according to claim 1, wherein in step b) only quenching is carried out in a quencher unit by direct contact with a stream of cool water pressurized at from 10 to 40 bar.

7. The process according to claim 1, wherein a part of oxygen obtained in the electrolysis step c) is recycled at step a), whereas the remaining part being pure oxygen is stocked for being sold as high-grade oxygen.

8. The process according to claim 1, wherein dry hydrogen coming from step d) is split into two streams wherein the first one is recycled to step a), whereas the second one is mixed with external CO2 heated and sent to step e) wherein the reverse water gas shift is carried out.

9. The process according to claim 4, wherein the steam stream leaving the boiler or the steam leaving the quencher is split into two streams, wherein the first one is sent to SOEC and the second one is sent to a turbine and expanded or in alternative, after being previously cooled is recycled to step a).

10. The process according to claim 1 for carrying out step a)-b) and e) comprising a shell wherein steps a) and b) are carried out and tube bundles wherein step e) is carried out, and wherein:
hydrogen, oxygen and steam enter at the bottom of the shell side and at the top of the tubes side CO₂ and H₂ enter, these tubes, wherein the endothermic reverse water gas shift reaction takes place, being heated by the exothermic reaction occurring at the shell side, and the syngas produced leaves the unit at the bottom of the unit, steam produced at the shell side enters a quenching unit, where its temperature is regulated by contact with cold water, before leaving the unit and being partially provided to SOEC.

11. An apparatus for carrying out the process according to claim 1 comprising the following units:
A) an H₂ burner unit for carrying out step a) said unit being in fluid communication with a steam quencher for carrying out step b),
B) a steam quencher for carrying out step b), this unit being in fluid communication with the H₂ burner and a solid oxide electrolytic cell (SOEC) unit,
C) a solid oxide electrolytic cell wherein the step c) takes place, this unit being in fluid communication with the H₂ burner unit and a reverse water gas shift reaction unit;
D) a reverse water gas shift reaction unit being in fluid communication with the H₂ burner and with the solid oxide electrolytic cell.

12. The apparatus according to claim 10 wherein the unit A), B) and D) are comprised in a sole unit comprising:
i) a shell being a H2 burner, coinciding with unit A)
ii) said shell surrounding a tube bundle coinciding with unit C)
iii) said shell comprising a steam quencher, coinciding with unit B)
said unit being further provided:
with three inlets for H2, O2 and steam at the shell side,
with an outlet for hot effluents at the same shell side,
with an inlet for cold water (CW) at the shell side in fluid communication with the quenching unit;
with an inlet for introducing the reactants at the tube side
and an outlet for syngas formed at the tube side.

13. The apparatus according to claim 12, wherein the steam quencher iii) is of direct type selected from a spray nozzle crown, or of indirect type selected from a heat exchanger or a waste heat boiler.

14. The apparatus according to claim 12, wherein the outlet of the shell side effluents is at the top of said unit, the inlet of the tube side reactant is at the top of said unit, the outlet of the tube side effluents are at the bottom of the unit, whereas the steam quenching unit is placed at the top of said unit.

15. The apparatus according to claim 1 wherein the outlet of the shell side effluents is at the bottom of the unit, the inlet of the tube side reactants is at the bottom of the unit and the outlet of the tube side effluents is at the top of the unit, the shell side steam quenching unit at is at the bottom of this unit.
